(19) United States
(12) Patent Application Publication
(10) Pub. No.: US 2020/0143235 A1
(43) Pub. Date: May 7, 2020

(54) SYSTEM AND METHOD FOR PROVIDING SMART OBJECTS VIRTUAL COMMUNICATION

(71) Applicant: Honda Motor Co., Ltd., Tokyo (JP)

(72) Inventors: Shigeyuki Seko, Campbell, CA (US); Shinichi Akama, Cupertino, CA (US)

(21) Appl. No.: 16/178,084

(22) Filed: Nov. 1, 2018

(51) Int. Cl. G06N 3/08; G10L 13/04

(52) U.S. Cl. CPC G06N 3/08; G10L 13/043

(57) ABSTRACT

A system and method for providing smart objects virtual communication that includes analyzing at least one function of the smart objects. The system and method also includes analyzing a frequency of use of the smart objects and analyzing at least one statement spoken by a user to the smart objects. The system and method also includes controlling the smart objects to virtually communicate with the user based on at least one of: the at least one statement spoken by the user, the at least one function of the smart objects, and the frequency of use of the smart objects.

### BACKGROUND

Many objects are being connected to devices to allow them to become “smart objects” that may provide autonomous functions. Many of the smart objects may communicate amongst each other through an internet of things (loT) system of interrelated smart objects. Such communication may provide an ability to transfer data over a wireless network without requiring human-to-human or human-to-computer interaction. However, in many cases, objects may require pre-programming and a high amount of customization to allow objects to provide customized functions that may pertain to individuals. In many cases, even after much time is spent pre-programming and customizing each of the smart objects, the smart objects do not perform functions in the manner specifically intended by the individual.

Currently, as smart objects are utilized at a greater extent, individuals may have numerous smart objects that may be located in an environment such as a home. In many cases, interaction with a particular smart object to utilize the functionality of that smart object may be complicated based on multiple smart objects interpreting one or more commands provided by the individuals and/or initiating communications with the individuals. In such cases, the functionality intended to be utilized by the individuals may not be efficiently provided to the individuals.

### BRIEF DESCRIPTION

According to one aspect, a computer-implemented method for providing smart object virtual communication that includes analyzing at least one function of a smart object. The computer-implemented method also includes analyzing a frequency of use of the smart object and analyzing at least one statement spoken by a user to the smart object. The computer-implemented method further includes controlling the smart object to virtually communicate with the user based on at least one of: the at least one statement spoken by the user, the at least one function of the smart object, and the frequency of use of the smart object.

According to another aspect, a system for providing smart object virtual communication that includes a memory storing instructions when executed by a processor that cause the processor to analyze at least one function of a smart object. The instructions also cause the processor to analyze a frequency of use of the smart object and analyze at least one statement spoken by a user to the smart object. The instructions further cause the processor to control the smart object to virtually communicate with the user based on at least one of: the at least one statement spoken by the user, the at least one function of the smart object, and the frequency of use of the smart object.

According to a further aspect, non-transitory computer readable storage medium storing instructions that when executed by a computer, which includes a processor to perform a method. The method includes analyzing at least one function of a smart object. The method also includes analyzing a frequency of use of the smart object and analyzing at least one statement spoken by a user to the smart object. The method further includes controlling the smart object to virtually communicate with the user based on at least one of: the at least one statement spoken by the user, the at least one function of the smart object, and the frequency of use of the smart object.

### BRIEF DESCRIPTION OF THE DRAWINGS

FIG. 1 is a schematic view of an exemplary operating environment of a smart object communication system according to an exemplary operating embodiment of the present disclosure;

FIG. 2A is an illustrated example of a smart object configured as a smart chair that includes a plurality of sensors of a sensor system according to an exemplary embodiment;

FIG. 2B is an illustrated example of the virtual representation of the smart object configured as the smart chair according to an exemplary embodiment;

FIG. 3 is a process flow diagram of a method for training the neural network with respect to smart objects executed by an object communication application according to an exemplary embodiment;

FIG. 4 is a process flow diagram of a method for presenting a virtual personality of the smart objects to virtually communicate with a user and perform one of more functions according to an exemplary embodiment; and

FIG. 5 is a process flow diagram of a method for providing smart object virtual communication according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting.

A “processor,” as used herein, processes signals and performs general computing and arithmetic functions. Signals processed by the processor can include digital signals, data signals, computer instructions, processor instructions, messages, a bit, a bit stream, or other computing that can be received, transmitted and/or detected.

A “bus”, as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “database”, as used herein can refer to table, a set of tables, a set of data stores and/or methods for accessing and/or manipulating those data stores. Some databases can be incorporated with a disk as defined above.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications can be sent and/or received. An operable connection can include a wireless interface, a physical interface, a data interface and/or an electrical interface.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (EV) and plug-in hybrid electric vehicles (PHEV). The term “vehicle” can also refer to an autonomous vehicle and/or self-driving vehicle powered by any form of energy. The autonomous vehicle may or may not carry one or more human occupants. Further, the term “vehicle” can include vehicles that are automated or non-automated with pre-determined paths or free-moving vehicles.

A “value” as used herein can include, but is not limited to, a numerical or other kind of value or level such as a percentage, a non-numerical value, a discrete state, a discrete value, a continuous value, among others. The term “value” as used throughout this detailed description and in the claims refers to any numerical or other kind of value for distinguishing between two or more states of X. For example, in some cases, the value may be given as a percentage between 0% and 100%. In other cases, the rating could be a value in the range between 1 and 10. In still other cases, the value may not be a numerical value, but could be associated with a given discrete state, such as “not X”, “slightly x”, “x”, “very x” and “extremely x”.

### I. System Overview

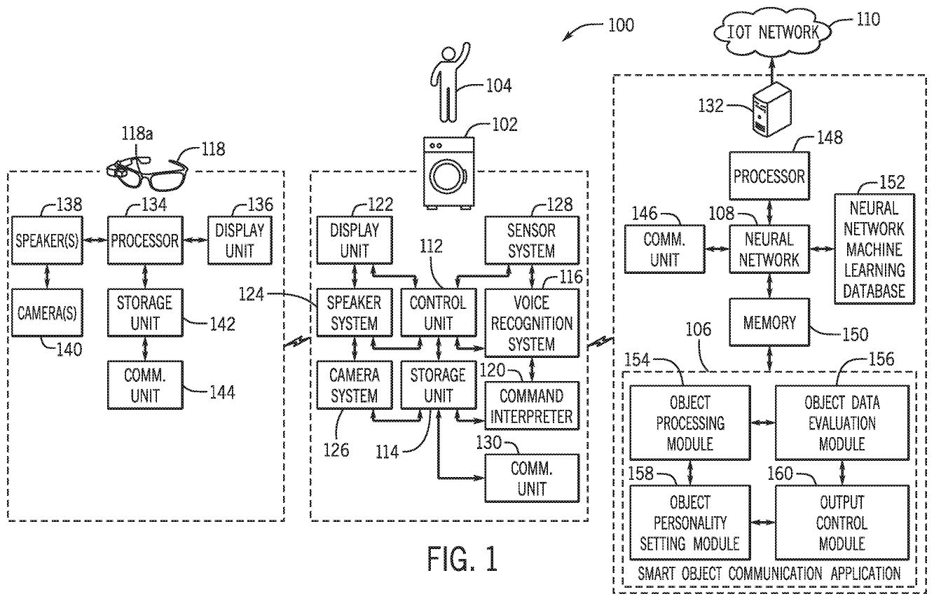

Referring now to the drawings, wherein the showings are for purposes of illustrating one or more exemplary embodiments and not for purposes of limiting the same, FIG. 1 is a schematic view of an exemplary operating environment of a smart object communication system 100 (object communication system) according to an exemplary operating embodiment of the present disclosure. The components of the object communication system 100, as well as components of other systems, hardware architectures and software architectures discussed herein, may be combined, omitted or organized into different architecture for various embodiments. However, the exemplary embodiments discussed herein focus on the system 100 as illustrated in FIG. 1, with corresponding system components, and related methods.

As shown in the illustrated embodiment of FIG. 1, the system 100 may include one or more smart objects 102 that may be located within an environment (not shown) (e.g., home, office, vehicle, etc.). The smart objects 102 may be configured to provide one or more respective functions that may be executed and utilized by (e.g., for) one or more individuals. As discussed in more detail below, the object communication application 106 may be configured to control the smart objects 102 to communicate with a user 104 based on one or more functions of the smart objects 102, a frequency of the user's use of the smart objects 102, a frequency of the user's use of functions of the smart objects 102, one or more statements spoken by the user 104 to the smart objects 102, and/or one or more physical actions expressed by the user 104 that may pertain to the smart objects 102.

The object communication application 106 may be configured to provide and present a virtual personality of the smart objects 102 that is exhibited by the smart objects 102. The virtual personality may be utilized to provide a pattern of communication (e.g., via speech) to the user 104 to provide various statements/responses. Additionally, the virtual personality may be utilized to provide a virtual representation that may exhibit one or more behavioral attributes that may include facial expressions, body language, body movement, and the like. The virtual personality may be presented in a form of a virtual graphic that may be associated with the smart objects 102.

As discussed in more detail below, the object communication application 106 may be configured to train a neural network 108 with data pertaining to the smart objects 102. The application 106 may continually train the neural network 108 with respect to the utilization and functionality of the smart objects 102 to build a data set that may be utilized to select behavioral attributes and communication patterns of the smart objects 102 provided by one or more of the smart objects 102 to the user 104 to thereby present the virtual personality of the smart objects 102.

With particular reference to the smart objects 102, the smart objects 102 may include various types/configurations of objects that may include, but may not be limited to, appliances, machinery, vehicles, electronic devices, furnishings, etc. For example, the smart objects 102 may include house hold appliances such as a washers, dryers, refrigerators, microwaves, ranges, heaters, air conditioners, fans, lamps, televisions, audio systems, and the like. The smart object 102 may also include furniture/accessories that may include a couch, a chair, a table, a vase, and the like.

For purposes of simplicity, illustrative examples of the smart objects 102 (and additional smart objects) discussed within this disclosure may pertain to household appliances and furniture/accessories. However, it is to be appreciated that the smart object 102 may pertain to various types of objects/devices/machinery that are embedded with hardware, software, sensors, and actuators that may be operably connected to and/or may communicate with the user 104 and/or additional smart objects 102.

In one or more embodiments, the smart objects 102 may be configured to connect and communicate through an Internet of Things network (loT network) 110. The IoT network 110 may include a network of one or more smart objects 102 and computing systems that may located within one or more environments and may be configured to communicate amongst one another through the IoT network 110. With continued reference to FIG. 1, in an exemplary embodiment, the smart objects 102 may include a control unit 112 that operably controls a plurality of components of the smart objects 102.

In an exemplary embodiment, the control unit 112 of the smart objects 102 may include a processor (not shown), a memory (not shown), a disk (not shown), and an input/output (I/O) interface (not shown), which are each operably connected for computer communication via a bus (not shown). The I/O interface provides software and hardware to facilitate data input and output between the components of the control unit 112 and other components, networks, and data sources, of the system 100. In one embodiment, the control unit 112 may execute one or more operating systems, applications, and/or interfaces that are associated with the smart objects 102.

In an exemplary embodiment, the control unit 112 may be operably connected to a storage unit 114. The storage unit 114 of the smart objects 102 may store one or more operating systems, applications, associated operating system data, application data, object configuration data, object execution data, and object subsystem data that may be executed by the control unit 112 of the smart objects 102. In one embodiment, the object communication application 106 may store application data on the storage unit 114.

In one or more embodiments, the application data may include a smart object profile that may be associated with each of the smart objects 102. The smart object profile may be pre-populated with object identification data that may include, but may not be limited to, a make, a model, a serial number, a product number, a product code, a model date/date of production code, and one or more component codes that are each associated to the respective smart objects 102. The smart object profile may also be pre-populated with one or more function codes that may be interpreted by the application 106 and/or the neural network 108 to determine one or more particular functions that may be executed by each of the respective smart objects 102.

In particular, the function codes may apply to particular functions (e.g., enable wash, speed wash, baby clothes wash, book recommendation, seat welcoming, task reminder, lamp ON, lamp OFF, etc.) that may be provided by the respective smart objects 102. Stated differently, the application 106 may maintain a plurality of function codes that may apply to functions provided by a variety of different types of objects including the smart objects 102 that may be pre-populated to the smart object profile of each the respective smart objects 102 by a manufacturer, third-party, and/or the user 104.

In one or more embodiments, the smart object profile may also be continually populated with behavioral attribute and communication pattern data that is associated to the virtual representation and virtual communication patterns of the smart objects 102. The behavioral attribute and communication pattern data may be continually populated by a manufacturer and/or a third party and may be utilized to provide one or more visual representations of the smart objects 102 and (vocal) statements/responses to the user 104. In particular, the behavioral attribute and communication pattern data may include one or more data points that pertain to one or more visual representations, one or more facial expressions, one or more body movements, one or more vocal statements, one or more characters, one or more voices, one or more voice inflections, and the like that may be utilized by the object communication application 106 to present the virtual personality of the smart objects 102.

As discussed below, the object communication application 106 may utilize the behavioral attribute and communication pattern data to set behavioral attributes and communication patterns of the smart objects 102 based on one or more functions of the smart objects 102, the frequency of use of the smart objects 102, and one or more statements and/or behavioral actions of the user 104 with respect to the smart objects 102.

In one embodiment, the smart object profile may be continually populated with user specific data. The user specific data may include, but may not be limited to, an object name (e.g., nickname) selected by the user 104 that may pertain to each of the respective smart objects 102, one or more trigger phrases, one or more customizable commands that may include one or more command phrases that may be pre-programmed to command the (particular/specific) smart objects 102 to enable (particular/specific) functions for the user 104. The user specific data may additionally be populated with one or more time stamps that are associated with the one of more function codes that pertain to the particular utilization (e.g., frequency of utilization based on particular times of execution) of one or more particular functions of each of the smart objects 102 by the user 104. As discussed below, the time stamps that are associated with the one or more function codes may be evaluated to determine a frequency of use of each of the one or more smart objects 102 and/or particular functions of each of the smart objects 102.

In an additional embodiment, the profile may continually be populated with network addresses (e.g., internet protocol addresses) of one or more additional smart objects 102 that are connected to the IoT network 110. The network addresses may be utilized by a communication unit 130 of each of the smart objects 102 to communicate with the one or more additional smart objects 102 that are connected to the IoT network 110. As discussed below, data included within each profile of each of the one or more smart objects 102 may be communicated to the neural network 108 to train the neural network 108 with respect to the smart objects 102.

In an additional embodiment, the application 106 may utilize the storage unit 114 to store a profile associated with the user 104 (user profile). The user profile may be populated with information pertaining to the user 104 that may include, but may not be limited to, the user's name, the user's birthdate, payment information pertaining to one or more of the user's (bank/payment) accounts, the user's contact information, etc. The information pertaining to the user 104 may be utilized by the application 106 and/or the smart objects 102 to provide one or more particular functions that may specifically apply to the user 104. In one or more embodiments, the user profile associated with the user 104 may also be populated with various types of data, including vocal identification data, image identification data, and portable device identification data that may be analyzed by the application 106 and/or the smart objects 102 to identify the user 104 and determine the presence of the user 104 within a predetermined proximity (e.g., 15 feet) of the smart objects 102.

In one embodiment, the control unit 112 may operably be connected a voice recognition system 116. In one configuration, the voice recognition system 116 may be implemented as a hardware device of the smart objects 102 and may include one or more microphones (not shown) disposed within a form factor of the smart objects 102 and/or attached to a body of the smart objects 102. The voice recognition system 123 may also include hardware configured to receive voice data (e.g., sensed voices) spoken within the predetermined proximity of the smart objects 102.

In some configurations, the voice recognition system 116 may communicate with an associated voice recognition system (not shown) of a respective portable device 118 (discussed in more detail below) used by the user 104 to receive voice data provided by the user 104 via one or more microphones (not shown) of the portable device 118. For purposes of simplicity, the voice recognition system 116 of the smart objects 102 will be discussed in more detail within this disclosure. However, it is to be appreciated that the disclosure with respect to the functionality of the voice recognition system 116 may also apply to the associated voice recognition system of the portable device 118.

In one or more configurations, the voice recognition system 116 may be enabled to analyze voices in the form of voice data that is sensed by the microphone(s). The voice recognition system 116 may be configured to locate human speech patterns to be analyzed to determine one or more statements/commands that are communicated to the smart objects 102 by the user 104. In an additional embodiment, the voice recognition system 116 may be configured to sense a particular object name (e.g., nickname), a trigger phrase(s), and/or a customizable command(s) that is assigned to the smart objects 102 by the user 104 and is spoken by the user 104. Upon sensing spoken object name, trigger phrase(s), and/or customizable command(s), the voice recognition system 116 may analyze the voice data sensed by the microphone(s). For example, the phrase “washer” as the object name may be utilized to enable the voice recognition system 116 to further analyze the voice data sensed by microphone(s) of a particular one of the smart objects 102 that is configured as a washing machine to receive one or more statements spoken by the user 104.

In one or more embodiments, as discussed below, the object communication application 106 may utilize the voice recognition system 116 to generate a textual or other simple representation of one or more words in the form of the voice input(s) that is provided by the voice recognition system 116 to a command interpreter 120 of the smart objects 102. In some embodiments, the voice recognition system 116 may generate multiple possible words or phrases such as when the voice recognition system 116 may not resolve the spoken word or phrase with 100% certainty. In such embodiments, the voice recognition system 116 may provide possible phrases in the form of voice inputs to the command interpreter 120. The voice recognition system 116 may also provide a “confidence value” within the voice inputs for each such possible phrase indicating how confident the voice recognition system 116 is that each possible phrase was the actual phrase spoken.

In one embodiment, the voice recognition system 116 may also be utilized by the application 106 (e.g., during an initial execution/setup of the application 106) to learn the voice of the user 104 and to access the storage unit 114 to populate the user profile associated with the user 104 with vocal identification data. The vocal identification data may be utilized to identify the user 104 based on the user's speech. In particular, the object communication application 106 may utilize the voice recognition system 116 to analyze real-time speech as sensed by the microphone(s) against the vocal identification data included with the user profile associated with the user 104 to identify the user 104 based on the user's speech and in some instances to determine if the user 104 is located within the predetermined proximity of the smart objects 102. Upon identifying the user 104, the application 106 may further utilize the voice recognition system 116 to provide additional data to the command interpreter 120 that pertains to the voice input(s) to be analyzed to determine one or more statements that may be spoken by the user 104 to communicate with the smart objects 102.

In an exemplary embodiment, the command interpreter 120 may be configured to receive data pertaining to the voice input(s) based on the speech of the user 104 as provided by the voice recognition system 116. The command interpreter 120 may also be configured to analyze the voice input(s) to determine the one or more statements based on the voice input(s) as determined based on the user's speech. In some configurations, the command interpreter 120 may communicate with an associated interpreter (not shown) of the portable device 118 used by the user 104 to receive the voice input(s). For purposes of simplicity, the command interpreter 120 of the smart objects 102 will be discussed in more detail within this disclosure. However, it is to be appreciated that the disclosure with respect to the functionality of the command interpreter 120 may also apply to the associated interpreter of the portable device 118.

In one configuration, the one or more statements spoken by the user 104 may be recognized as one or more words, commands, requests, questions and the like that may be spoken by the user 104 to communicate with the smart objects 102. In one or more embodiments, the command interpreter 120 may communicate with the neural network 108 to execute multimodal processing and/or machine learning to perform speech pattern recognition to determine one or more phrases spoken by the user 104 that may pertain to providing the one or more statements. The neural network 108 may provide speech data to the command interpreter 120 that may be further analyzed to determine the one or more statements.

As discussed below, upon determining the one or more statements, the command interpreter 120 may provide the one or more statements to the object communication application 106 in the form of statement data. The application 106 may utilize the neural network 108 to analyze the statement data pertaining to the one or more statements interpreted by the command interpreter 120 to determine which of the smart objects 102 and/or which of the functions of the smart objects 102 that the statements may apply.

In some embodiments, one or more of the smart objects 102 may include a respective display unit 122 that may be disposed at one or more areas of one or more respective smart objects 102. The display unit 122 may be utilized to display one or more application human machine interfaces (application HMI) to provide the user 104 with various types of information related to the smart objects 102 and/or to receive one or more inputs from the user 104. The display unit 122 may be capable of receiving inputs from the user 104 directly or through an associated keyboard/touchpad (not shown). In one embodiment, the application HMIs may pertain to one or more application interfaces, including one or more user interfaces associated with the object communication application 106.

In one embodiment, the object communication application 106 may be configured to communicate with the control unit 112 to operably control the display unit 122 to present a virtual communication interface of the application 106. The virtual communication interface may present a virtual representation of the smart objects 102 (e.g., a virtual graphic of an individual) that may be presented during virtual communication between the user 104 and the smart objects 102. The virtual representation may be presented to the user 104 as a graphical moving/video as virtual communication is being conducted between the user 104 and the smart objects 102. For example, the virtual representation may be presented as a virtual avatar shown as an individual's (e.g., known or unknown to the user 104) face. The virtual avatar may be shown with facial expressions, body movements, eye movements, and body language to present the virtual personality of the smart objects 102 during virtual communication with the user 104.

In an exemplary embodiment, the control unit 112 may additionally be operably connected to a speaker system 124 of the smart objects 102. The speaker system 124 may include one or more speakers (not shown) (e.g., various speaker configurations) that may be disposed at one or more areas of the smart objects 102. In one embodiment, the one or more speakers of the speaker system 124 may be utilized by the application 106 to provide a synthesized voice to communicate vocal communication patterns (e.g., to greet the user 104, to initiate communication, to provide statement(s) during execution of one or more functions, response to questions and/or commands, etc.) during virtual communication. Accordingly, the control unit 112 may operably control the display unit 122 and the speaker system 124 to present the virtual representation through the virtual communication interface in synchronization with the vocal communication patterns to communicate with the user 104.

In one or more embodiments, the object communication application 106 may be configured to provide the synthesized voice of each of the smart objects 102 in a respective manner that may be based on one or more factors that may include, an age of each of the smart objects 102, a function of each of the smart objects 102, a frequency of use of each of the smart objects 102, a statement communicated by the user 104 to each of the smart objects 102, physical actions (e.g., facial expressions, body language, eye movements, body movements) exhibited by the user 104 with respect to the each of the smart objects 102, and a priority of communication determined by the application 106 for the each of the smart objects 102. In some configurations, one or more speakers of the speaker system 124 may be utilized to provide sound directivity in a direction of the user 104 based on a determined location of the user 104 with respect to the smart objects 102.

The manner of the synthesized voice may be provided in various vocal inflections, various speech volumes, various tones, various speeds, and the like that may be based on the one or more aforementioned factors. In one embodiment, the application 106 may be configured to communicate with the control unit 112 to operably control the display unit 122 to present the virtual representation of each of the smart objects 102 with facial expressions and/or body language that is associated with the manner of the synthesized voice.

As an illustrative example, smart objects 102 that may be more frequently utilized by the user 104 may speak in a personal manner to greet the user 104 by name in a friendly tone and make statements that pertain to the user's daily activities based on information provided by the user 104 and/or one or more additional smart objects 102. The virtual representation of the smart objects 102 may be presented as expressing happy facial expressions (e.g., smiling). Additionally, smart objects 102 that may not be as frequently utilized or may have never been previously utilized by the user 104 may speak in a more impersonal matter to ask for one or more commands.

As another illustrative example, one or more smart objects 102 may communicate with the user 104 in various manners based on a priority that is determined by the application 106 to apply to each of the smart objects 102 when the user 104 is located within a predetermined proximity of more than one of the smart objects 102. As discussed, the priority may be determined based on the frequency of use and/or one or more functions performed for the user 104. In some circumstances, a priority of one or more smart objects 102 may increase based on a particular statement(s) that are communicated to the user 104 (e.g., request communicated to the user 104 to replace a battery (not shown) of the smart objects 102).

In one or more embodiments, the control unit 112 may also be operably connected to a camera system 126 of the smart objects 102. The camera system 126 may be operably connected to one or more cameras (not shown) that may be disposed at one or more areas of the smart objects 102. The camera(s) may be configured to capture images/video of the user 104 located within an image capturing distance of the one or more of the camera(s). In one embodiment, the camera(s) of the camera system 126 may be configured to capture the presence of the user 104 as the user 104 walks towards, near, and/or away from the smart objects. The camera(s) may also be configured to capture facial expressions, body movements, eye gaze, and/or body language of the user 104.

As discussed below, the object communication application 106 may be configured to communicate with the control unit 112 to utilize the camera system 126 to provide image data pertaining to the presence of the user 104 and facial expressions, body movements, eye gaze, and body language of the user 104. The analysis of the image data by the application 106 and/or the neural network 108 may allow the application 106 to set a virtual representation and communication patterns of the smart objects 102 that the user 104 is physically approaching, looking toward, providing a gesture to, and/or is speaking with to provide the virtual personality of the smart objects 102 and/or to execute one or more functions of the smart objects 102. For example, if the environment includes multiple smart objects 102, the image data may be analyzed by the application 106 to determine if the user's eye gaze and/or gesture(s) is directed toward one or more particular smart objects 102 to thereby enable the respective smart objects 102 to communicate with the user 104 via the virtual representation and communication patterns.

In an exemplary embodiment, the smart objects 102 may include a sensor system 128 that may be operably controlled by the control unit 112. The sensor system 128 may include one or more sensors that may sense various types of measurements. The one or more sensors of the sensor system 128 may include, but may not be limited to, radar sensors, LiDAR sensors, weight sensors, proximity sensors, capacitive touch sensors, vibration sensors, and the like. In particular, the one or more sensors of the sensor system 128 may be configured to sense one or more measurements that are tied to one or more functions that may be provided by the smart objects 102. Accordingly, it is appreciated that the sensor system 128 of each respective smart object 102 may include one or more particular sensors that are not expressly disclosed herein and that may apply to the one or more functions of the particular smart objects 102.

In one embodiment, the sensor system 128 may be configured to output one or more sensor data signals indicating one or more respective measurements of data as sensed by the one or more sensors. The object communication application 106 may be configured to receive the sensor data to analyze the sensor data to determine one or more measurements that may be utilized to determine the presence of the user 104 within the predetermined proximity of the smart objects 102 and/or to determine communication patterns that are to be spoken to the user 104 in order to provide the virtual personality of the smart objects 102.

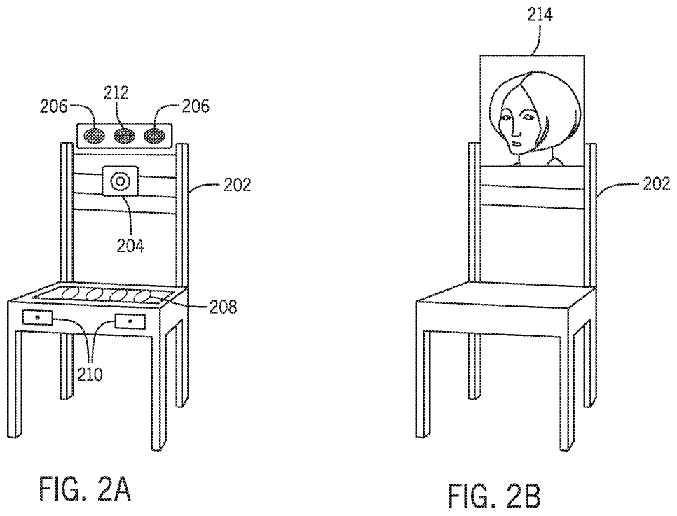

FIG. 2A is an illustrated example of a smart object 102 configured as a smart chair 202 that includes a plurality of sensors of the sensor system 128 according to an exemplary embodiment. As shown in the illustrative example, the smart object 102 configured as the smart chair 202 may include a camera 204 of the camera system 126, speakers 206 of the speaker system 124, and weight sensors 208 in addition to LiDAR sensors 210 of the sensor system 128. The smart chair 202 may additionally include a microphone 212 that is operably connected to the voice recognition system 116 and/or the command interpreter 120.

In an illustrative example, the camera system 126 may provide image data based on one or more images captured by the camera 204 to the object communication application 106. Additionally, the sensor system 128 may provide sensor data based on LiDAR measurements sensed by the LiDAR sensors 210 that may evaluate the image data and the sensor data and may determine that the user 104 is located within a predetermined proximity of the smart chair 202 and/or is seated on the smart chair 202.

Additionally, the command interpreter 120 may provide the one or more statements captured by the microphone 212 to the object communication application 106 in the form of statement data to be analyzed to determine communication patterns and a virtual representation of a virtual personality of the smart chair 202. The application 106 may further utilize the speaker system 124 of the smart chair 202 to provide the communication patterns to vocally communicate with the user 104 through the speakers 206. For example, if the object communication application 106 determines that the user 104 is located within a predetermined proximity of the smart chair 202, the smart object 102 may greet the user 104 by stating “hello Tom, would you like to have a seat?” based on the user's name stored within the user profile associated with the user 104 on the storage unit 114 and one or more functions of the smart chair 202 as analyzed by the application 106 and/or the neural network 108.

Also, if the user 104 asks “what is my weight,” the command interpreter 120 may provide speech data that may be analyzed by the neural network 108 to provide communication patterns based on sensor data provided by the weight sensors 208 pertaining to the weight of the user 104 seated on the smart chair 202. The application 106 may further utilize the speakers 206 to communicate the user's weight to the user 104 in the form of a vocal response. In some embodiments, the smart chair 202 may additionally include a display unit 122 (not shown in FIG. 2A) that may provide a virtual representation associated with the smart chair 202 that may be shown with facial expressions, body movements, and body language in synchronization with the communication patterns provided as vocal responses to thereby provide the virtual personality of the smart chair 202.

Referring again to FIG. 1, the one or more smart objects 102 may additionally include a communication unit 130. The communication unit 130 may be capable of providing wired or wireless computer communications utilizing various protocols to send/receive non-transitory signals internally to the plurality of components of the smart objects 102 and/or externally to external devices such as one or more additional smart objects 102, the portable device 118 used by the user 104 and/or an external server 132 that hosts the neural network 108. Generally, these protocols include a wireless system (e.g., IEEE 802.11 (Wi-Fi), IEEE 802.15.1 (Bluetooth®)), a near field communication system (NFC) (e.g., ISO 13157), a local area network (LAN), and/or a point-to-point system.

In one or more embodiments, the object communication application 106 may communicate with the control unit 112 of the smart objects 102 to operably control the communication unit 130 to send and/or receive data from the portable device 118, the external server 132, and one or more additional smart objects 102 that are connected to the IoT network 110. Such communication may allow the exchange of data that may be utilized to facilitate virtual communication between the smart objects 102 and the user 104.

With particular reference to the portable device 118 used by the user 104, for purposes of simplicity, the portable device 118 will be described in the context of a wearable device that may be configured as wearable eye glasses (as represented in FIG. 1) that includes visual and audio output components (e.g., lens displays and ear phones). However, it is to be appreciated that the portable device 118 may include, but may not be limited to, various types of wearable devices, handheld devices, mobile devices, smart phones, laptops, tablets and e-readers, etc. In one or more embodiments, the portable device 118 may be worn/used by the user 104 during virtual communication with the smart objects 102. In some embodiments, the object communication application 106 may be configured to provide the vocal communication patterns and visual representations of the smart objects 102 to the user 104 through the portable device 118.

In one or more embodiments, components of the portable device 118 may be operably controlled by a processor 134. The processor 134 may be configured to execute one or more applications including the object communication application 106. The processor 134 of the portable device 118 may also be configured to operably control a display unit 136 (e.g., display screens configured within lenses of wearable eye glasses) of the portable device 118 to present the virtual communication interface of the application 106.

The virtual communication interface may be presented via the display unit 136 of the portable device 118 to present the virtual representation of the smart objects 102 (e.g., virtual avatar) that may be presented during virtual communication between the user 104 and the smart objects 102. As shown in FIG. 2B, an illustrated example of the virtual representation 214 of the smart object 102 configured as the smart chair 202 according to an exemplary embodiment, the virtual representation 214 may be presented via the display unit 136 as an augmented reality image that is overlaid upon the smart object 102 configured as a smart chair 202.

With reference again to FIG. 1, the processor 134 of the portable device 118 may be operably connected to one or more speakers 138. The one or more speakers 138 may be configured as head phones and/or three-dimensional binaural speakers configured within a form factor of the portable device 118. In one embodiment, if the object communication application 106 determines that the user 104 is using (e.g., wearing) the portable device 118, the application 106 may communicate with the processor 134 to operably control the speaker(s) 138 to provide a synthesized voice to communicate vocal communication patterns (e.g., in a conversation, responses to questions, responses to statements) with the user 104 during virtual communication between the user 104 and the smart objects 102. Accordingly, the processor 134 may operably control the display unit 136 and the speaker(s) 138 to present the virtual representation through the virtual communication interface in synchronization with vocal communication patterns to communicate with the user 104.

In an exemplary embodiment, the portable device 118 may include one or more cameras 140 that may be operably controlled by the processor 134. The one or more cameras 140 may be configured to capture one or more images of a surrounding environment of the portable device 118. In one configuration, the one or more cameras may be disposed upon a front portion of a frame 118a of the portable device 118 and may be configured to capture images from a point of view of the user 104. Upon capturing of images, the one or more cameras may be configured to output image data to the processor 134. In one embodiment, the object communication application 106 may be configured to receive the image data and analyze the image data to determine one or more smart objects 102 that the user 104 is looking toward, approaching, or is within a predetermined proximity of. This determination may allow the application 106 to determine a particular smart object 102 that the user 104 may intend to interact with (e.g., communicate with, utilize).

In one embodiment, the processor 134 may additionally be operably connected to a storage unit 142. The storage unit 142 may store one or more operating systems, applications, associated operating system data, application data, application user interface data, and the like that are executed by the processor 134 and/or one or more applications including the object communication application 106. In one embodiment, the storage unit 142 of the portable device 118 may store the (e.g., copy of) the user profile that is stored by the object communication application 106. As discussed, the user profile associated with the user 104 may be populated with various types of data, including vocal identification data, image identification data, and/or portable device identification data (e.g., a serial number of the portable device 118) that may be analyzed by the application 106 and/or the smart object 102 to determine the presence of the user 104 within a predetermined proximity of the smart object 102.

In an exemplary embodiment, the processor 134 may additionally be operably connected to a communication unit 144 of the portable device 118. The communication unit 144 may include antennas and components that may be utilized for wired and wireless computer connections and communications via various protocols. The communication unit 144 may be capable of providing a wireless system (e.g., IEEE 802.11, IEEE 802.15.1 (Bluetooth®)), a near field communication system (NFC) (e.g., ISO 13157), a local area network (LAN), a wide area network (WAN), a point-to-point system, a circuit switching system, a packet switching system, a cellular network system (e.g., CDMA, GSM, LTE, 3G, 4G), a universal serial bus, and the like.

In one embodiment, the communication unit 144 may be configured to wirelessly communicate with the communication unit 130 of the smart objects 102 to send and receive data associated with one or more applications including the object communication application 106. The communication unit 144 may also be configured to wirelessly communicate with a communication unit 146 of the external server 132 to send and receive data associated with one or more applications including the object communication application 106.

With particular reference to the external server 132, the server 132 may host a plurality of computing systems, databases, and engines (e.g., internet/web search engines) that may be accessed by the application 106 to evaluate and determine vocal communication patterns and the virtual representation of the smart objects 102. In one embodiment, the external server 132 includes a processor 148 for providing processing and computing functions. The processor 148 may be configured to control one or more components of the external server 132. The processor 148 may also be configured to execute one or more applications including the object communication application 106. In one embodiment, the processor 148 may be configured to operably control the neural network 108 stored on a memory 150 of the external server 132. In alternate embodiments, the neural network 108 or specific subsets (not shown) of the neural network 108 may also be hosted and/or executed by the smart objects 102 or the portable device 118 used by the user 104.

In one or more embodiments, the processor 148 of the external server 132 may include one or more machine learning sub-processors (not shown) that may execute various types of machine learning methods and/or deep learning methods that may be utilized to build and maintain a neural network machine learning database 152 to train the neural network 108 with information that is populated from the smart object profile and/or the user profile to provide artificial intelligence capabilities. The neural network 108 may utilize the processor 148 to process a programming model which enables computer based learning that is based on one or more forms of data that are provided to the neural network 108 through training and/or learned by the neural network 108. The processor 148 may thereby process information that is provided as inputs and may utilize the neural network machine learning database 152 to access stored machine learned data to provide various functions.

In particular, the neural network 108 may be trained by the application 106 to add and/or update data on the neural network machine learning database 152 pertaining to a smart objects identification that may include identifying information (e.g., make, model, serial number), one or more object names (e.g., nickname) selected by the user 104 that may respectively pertain to the one or more smart objects 102, one or more trigger phrases, one or more customizable commands that may include one or more command phrases that may be pre-programmed to command the smart objects 102 to enable particular functions for the user 104.

The neural network 108 may also be trained based on additional data that is populated to the neural network machine learning database 152 as provided by a manufacturer of the smart objects 102 and/or one or more third parties through communications with the neural network 108 via the communication unit 146 of the external server 132 through the IoT network 110 and/or an internet (not shown). The manufacturer of the smart objects 102 and/or one or more third parties may communicate a plurality of communication patterns to be utilized based on a particular context of statement(s) communicated to the smart objects 102 during virtual communication with the smart objects 102, one or more particular functions provided by the smart objects 102, a frequency of use of the smart objects 102, facial expressions, body language, body movements, and/or eye gaze exhibited by the user 104 during virtual communication with each respective smart object 102, and/or a priority of communication determined by the application 106 for each respective smart object 102.

In some configurations, the neural network machine learning database 152 may be populated based on data that is communicated by the application 106 to the neural network 108. Such data may pertain to each instance of virtual communication between the user 104 and the smart objects 102, the utilization of one or more functions during each virtual communication session, data pertaining to a frequency of use of the smart objects 102, facial expressions, body language, body movements exhibited by the user 104 during virtual communication with each respective smart object 102, and a priority of communication determined by the application 106 for each respective smart object 102 during each instance of virtual communication between the user 104 and the smart objects 102. The neural network 108 may accordingly be continually trained with additional data based on on-going utilization of the smart objects 102 by the user 104 and/or virtual communications conducted between the user 104 and the smart objects 102 to thereby improve virtual communications between the user 104 and the smart objects 102.

In an exemplary embodiment, the communication unit 146 of the external server 132 may be configured to wirelessly connect to an internet cloud and/or the IoT network 110. In particular, the communication unit 146 may be capable of providing a wireless system (e.g., IEEE 802.11, IEEE 802.15.1 (Bluetooth®)), a near field communication system (NFC) (e.g., ISO 13157), a local area network (LAN), a wide area network (WAN), a point-to-point system, a circuit switching system, a packet switching system, a cellular network system (e.g., CDMA, GSM, LTE, 3G, 4G), a universal serial bus, and the like.

In one embodiment, the communication unit 144 may be configured to wirelessly communicate with the communication unit 144 of the smart object 102 (e.g., through the internet cloud) to send and receive data associated with one or more applications including the object communication application 106. The communication unit 146 may also be configured to wirelessly communicate with the communication unit 144 of the portable device 118 to send and receive data associated with one or more applications including the object communication application 106.

### The Smart Object Communication Application and Methods Executed by the Application

The components of the object communication application 106 will now be described according to an exemplary embodiment and with reference to FIG. 1. In an exemplary embodiment, the object communication application 106 may be stored on the storage unit 114 of the smart objects 102. In alternate embodiments, the object communication application 106 may also/alternatively be stored on the memory 150 of the external server 132 and/or the storage unit 142 of the portable device 118. In an exemplary embodiment, the object communication application 106 may include a plurality of modules that may include, but may not be limited to an object processing module 154, an object data evaluation module 156, an object personality setting module 158, and an output control module 160. It is to be appreciated that the application 106 may include one or more additional modules and/or sub-modules that are provided in addition to the modules 154-160.

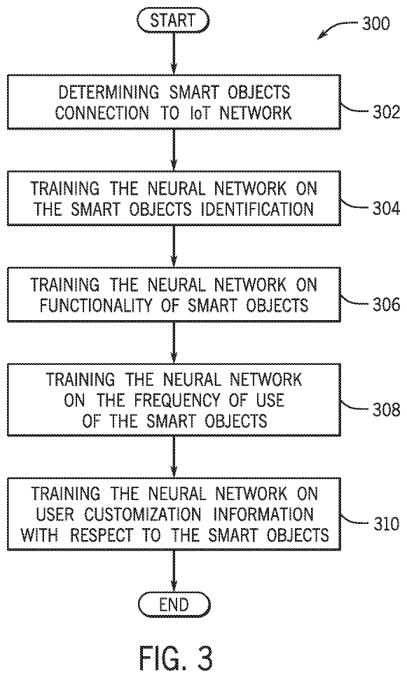

FIG. 3 is a process flow diagram of a method 300 for training the neural network 108 with respect to the smart objects 102 executed by the object communication application 106 according to an exemplary embodiment. FIG. 3 will be described with reference to the components of FIG. 1 though it is to be appreciated that the method of FIG. 3 may be used with other systems and/or components. The method 300 may begin at block 302, wherein the method 300 may include determining smart objects connection to the IoT network 110.

In an exemplary embodiment, the object processing module 154 of the object communication application 106 may be configured to communicate with the external server 132 to determine one or more smart objects 102 that are connected to the IoT network 110. In one configuration, the memory 150 of the external server 132 may store an object list of one or more network addresses of one or more smart objects 102 that are connected to the IoT network 110. In particular, the object list may include the network addresses of one or more smart objects 102 that have previously and continue to be connected (e.g., have not been disconnected for a predetermined period of time) to the IoT network 110.

In one embodiment, the object processing module 154 may be configured to communicate with the external server 132 to determine when one or more smart objects 102 are connected to the IoT network 110 for a first time or are reconnected to the IoT network 110 after being disconnected after a predetermined period of time. The external server 132 may analyze the object list within the memory 150 to determine if one or more network addresses of one or more smart objects 102 are already listed or if the one or more network addresses of one or more smart objects 102 will be added based on their new connection/reconnection the IoT network 110. If it is determined that one or more smart objects 102 are newly connected/reconnected to the IoT network 110, the external server 132 may communicate respective data to the object processing module 154.

The method 300 may proceed to block 304, wherein the method 300 may include training the neural network 108 on the smart objects identification. In an exemplary embodiment, upon determining that one or more smart objects 102 are added or re-added based on their new connection/reconnection to the IoT network 110, the object processing module 154 may be configured to communicate with the control unit 112 of the (newly added/reconnected) smart objects 102 to receive object identification data. In particular, the control unit 112 may access the storage unit 114 to access the smart object profile associated with each respective smart object 102 of the one or more smart objects 102 that are added or re-added.

The smart object profile of each respective smart object 102 may be pre-populated with object identification data that may include, but may not be limited to, a make, a model, a serial number, a product number, a product code, a model date/date of production code, and one or more component codes that are each associated to the respective smart object 102. In one embodiment, the object identification data communicated by the control unit 112 to the object processing module 154 of the respective smart objects 102 may include object identification data pre-populated within the smart object profile.

Upon receiving the object identification data, the object processing module 154 may communicate with the processor 148 of the external server 132 to access the neural network 108. Upon accessing the neural network 108, the object processing module 154 may communicate the device identification data associated with the smart objects identification to the neural network 108. In an exemplary embodiment, the neural network 108 may access the neural network machine learning database 152 and may populate the neural network machine learning database 152 with a new record (e.g., data record) that is associated with respective (newly connected/reconnected) smart device(s) 102. The data record may be populated with one or more data fields and associated machine learning executable language that pertains to each respective smart object device identification. In particular, the one or more data fields may be populated with object identification data that may include, but may not be limited to, a make, a model, a serial number, a product number, a product code, a model date/date of production code, and one or more component codes that are each associated to the respective smart objects 102.

The method 300 may proceed to block 306, wherein the method 300 may include training the neural network 108 on the functionality of the smart objects 102. In an exemplary embodiment, upon determining that one or more smart objects 102 are added or re-added based on their new connection/reconnection the IoT network 110, and upon determining the smart objects identification, the object processing module 154 may be configured to continually communicate with the control unit 112 of the (newly added/reconnected) smart objects 102 to receive functionality data each time the smart objects 102 has been utilized. This functionality may allow the object processing module 154 to determine a current listing of the one or more functions of each respective smart object 102 that may change based on hardware, software, and/or firmware upgrades to the respective smart object 102.

In one configuration, the control unit 112 may access the storage unit 114 to re-access the smart object profile associated with each respective smart object 102 of the one or more smart objects 102. The smart object profile of each respective smart object 102 may be pre-populated and updated (when applicable) with one or more function codes that may be communicated to the object processing module 154. Upon receiving the one or more function codes associated with each respective smart object 102, the object processing module 154 may access the neural network 108 and may communicate the one or more function codes to the neural network 108 to train the neural network 108 on the one or more functions that may be executed by the smart objects 102.

In one configuration, upon receiving the one or more function codes from the object processing module 154, the neural network 108 may access the neural network machine learning database 152 to access the record associated with the respective smart objects 102. Upon accessing the record associated with the respective smart objects 102, the neural network 108 may populate the record with one or more data fields and associated machine learning executable language that pertains to one or more functions that may be executed by the respective smart objects 102. This functionality ensures that the neural network 108 is continually trained with respect to each respective smart object's functionality in order to set the virtual representation, communication patterns, and to execute the one or more functions of the respective smart objects 102, as discussed in more detail below.

The method 300 may proceed to block 308, wherein the method 300 may include training the neural network 108 on the frequency of use of the smart objects 102. As discussed above, the user specific data within the smart object profile stored on the storage unit 114 of the smart objects 102 may be continually populated with timestamps that are associated with the frequency of utilization of the smart objects 102. The timestamps may be associated with the one or more function codes that pertain to the frequency of utilization of one or more particular functions of the smart objects 102 by the user 104.

In one embodiment, the object processing module 154 may be configured to continually communicate with the control unit 112 of the smart objects 102 to receive frequency of use data each time the smart objects 102 has been utilized. This functionality may allow the object processing module 154 to determine a current frequency of use with respect to one or more functions of each respective smart object 102 that may change based on behaviors of the user 104, interactions with the user 104, and/or the utilization of additional smart objects 102.

Upon receiving the one or more time stamps that are associated with one or more function codes that pertain the frequency of utilization of one or more particular functions of the smart objects 102 by the user 104, the object processing module 154 may access the neural network 108 and may communicate the one or more time stamps and associated function code data to the neural network 108 to train the neural network 108 on the frequency of use of the smart objects 102 by the user 104.

In one configuration, upon receiving the one or more time stamps from the object processing module 154, the neural network 108 may access the neural network machine learning database 152 to access the record associated with the respective smart objects 102. Upon accessing the record associated with the respective smart objects 102, the neural network 108 may populate the record with one or more data fields and associated machine learning executable language that pertains to one or more time stamps and associated function codes that may pertain to the frequency of utilization of the one or more functions of the respective smart objects 102. This functionality ensures that the neural network 108 is continually trained with respect to each respective smart object's frequency of utilization in order to set the personality and communication patterns of the respective smart objects 102, as discussed in more detail below.

The method 300 may proceed to block 310, wherein the method 300 may include training the neural network 108 on user customization information with respect to the smart objects 102. In one embodiment, the object processing module 154 may be configured to communicate with the control unit 112 of the smart objects 102 to operably control the display unit 122 to present an object customization user interface (not shown). Additionally or alternatively, the object processing module 154 may be configured to communicate with the processor 134 of the portable device 118 to operably control the display unit 136 to present the object customization user interface to the user 104 through the portable device 118. The object customization user interface may be utilized by the user 104 to input device identification data that may be subjective to the user 104. For example, the user 104 may add a nickname, key word(s), or subjective feature descriptions associated with each respective smart objects 102 that may be utilized as smart objects device identification.

The device training customization user interface may also allow the user 104 to input one or more customizable functions that the user 104 may utilize the smart objects 102 to execute. Additionally, the device training customization user interface may also allow the user 104 to input a priority that may be assigned to each smart object 102 of the one or more (newly connected/reconnected) smart objects 102. In an additional embodiment, the object processing module 154 may access the smart object profile on the storage unit 114 of the smart objects 102 to retrieve user specific data pertaining to customization information with respect to the smart objects 102. The user specific data pertaining to customization information may include, but may not be limited to, an object name selected by the user 104 that may pertain to the smart objects 102, one or more trigger phrases, one or more customizable commands that may include one or more command phrases that may be pre-programmed to command the smart objects 102 to enable particular functions for the user 104.

Upon receiving the customization information through inputs received via the object customization user interface and/or based on data included within the smart object profile of the smart objects 102, the object processing module 154 may access the neural network 108 and may communicate the customization information to train the neural network 108 with respect to subjective information pertaining to the user's utilization of the respective smart objects 102. In one configuration, upon receiving the customization information from the object processing module 154, the neural network 108 may access the neural network machine learning database 152 to access the record associated with the respective smart objects 102. Upon accessing the record associated with the respective smart objects 102, the neural network 108 may populate the record with one or more data fields and associated machine learning executable language that pertains to customization information. This functionality ensures that the neural network 108 is continually trained with respect to subjective information pertaining to the user's utilization of each respective smart object 102.

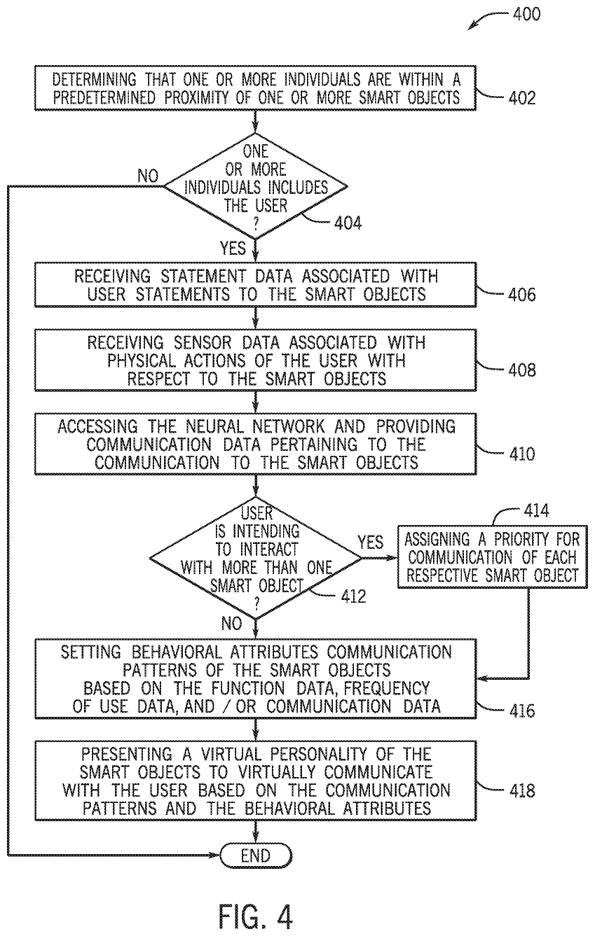

FIG. 4 is a process flow diagram of a method 400 for presenting a virtual personality of the smart objects 102 to virtually communicate with the user 104 and perform one of more functions according to an exemplary embodiment. FIG. 4 will be described with reference to the components of FIG. 1 though it is to be appreciated that the method of FIG. 4 may be used with other systems and/or components. The method 400 may be utilized to allow the smart objects 102 to virtually communicate with the user 104 in an environment (e.g., home) during execution of one or more functions that may be utilized by the user 104.

The method 400 may begin at block 402, wherein the method 400 may include determining that one or more individuals are within a predetermined proximity of one or more smart objects 102. In an exemplary embodiment, the object data evaluation module 156 of the object communication application 106 may be configured to communicate with the control unit 112 of the smart objects 102 to receive sensor data provided by the sensor system 128. The sensor system 128 may include one or more sensors that may sense various types of measurements related to the determining a presence of one or more individuals that may be located within a predetermined proximity of the smart objects 102. For example, one or more sensors of the sensor system 128 that may include, but may not be limited to, radar sensors, LiDAR sensors, and/or proximity sensors may be configured to sense one or more individuals that may be located (e.g., as they walk towards, away from, or near) the one or more respective smart objects 102.

In one embodiment, upon sensing that one or more individuals are located within the predetermined proximity of the smart objects 102, the sensor system 128 may communicate respective sensor data to the object data evaluation module 156 through the control unit 112. The object data evaluation module 156 may thereby determine that one or more individuals are within a predetermined proximity of one or more smart objects 102.

The method 400 may proceed to block 404, wherein the method 400 may include determining if one or more individuals that are located within the predetermined proximity of the smart objects 102 includes the user 104. In one embodiment, the object data evaluation module 156 may access the storage unit 114 of the smart objects 102 to retrieve the user profile associated with the user 104. The user profile associated with the user 104 may be populated with various types of data, including vocal identification data and image identification data that may be analyzed by the object data evaluation module 156 to identify that at least one of the individuals that are located within the predetermined proximity of the smart objects 102 includes the user 104.

In particular, if an individual(s) speaks a statement, the object data evaluation module 156 may communicate with the voice recognition system 116 to analyze the statement. In particular, the module 156 may utilize the voice recognition system 116 to analyze the vocal data in comparison with the voice identification data (populated within the user profile) to thereby determine if the user 104 is located within the predetermined proximity of the smart objects 102.

In another embodiment, the object data evaluation module 156 may communicate with the camera system 126 to capture one or more images/video of the predetermined proximity of the smart objects 102 and output image data associated with the captured image(s)/video. The module 156 may utilize the camera system 126 to analyze the image data in comparison with the image identification data (populated within the user profile) to thereby determine if the user 104 is located within the predetermined proximity of the smart objects 102.

In an alternate embodiment, the object data evaluation module 156 may be configured to communicate with the camera(s) 140 of the portable device 118. In particular, the object data evaluation module 156 may receive image data pertaining to the point of view of the user 104, body movements, body language of the user 104. The image data provided by the camera(s) 140 of the portable device 118 may be analyzed with respect to a point of view of the user 104 to thereby determine if the smart objects 102 is captured within the image data (based on the user 104 looking towards the smart objects 102). If the module 156 determines that the smart objects 102 is captured within the image data, the object processing module 154 may analyze the image data to determine a measured distance between the user 104 and the smart objects 102. The measured distance may be evaluated to determine if the portable device 118 and consequently the user 104 (e.g., wearing the portable device 118) is within the predetermined proximity of the smart objects 102.

If it is determined that one or more individuals includes the user 104 (at block 404), the method 400 may proceed to block 406, wherein the method 400 may include receiving statement data associated with user statements to the smart objects 102. In one embodiment, the object data evaluation module 156 may communicate with the voice recognition system 116 to enable the voice recognition system 116 to analyze statement data based on voices sensed by the one or more microphones of the one or more smart objects 102 (that the user 104 is within the predetermined proximity of).

The voice recognition system 116 may be configured to locate human speech patterns to be analyzed to determine one or more statements/commands that are communicated to the smart object 102 by the user 104. The voice recognition system 116 may also be configured to sense a particular object name (e.g., nickname), a trigger phrase(s), and/or a customizable command(s) that is assigned to one or more of the smart objects 102 by the user 104 and is spoken by the user 104.

In one embodiment, the object data evaluation module 156 may utilize the voice recognition system 116 to generate a textual or other simple representation of one or more words in the form of the voice input(s) that is provided by the voice recognition system 116 to the command interpreter 120 of the smart object 102. The command interpreter 120 may be configured to receive data pertaining to the voice input(s) based on the speech of the user 104 as provided by the voice recognition system 116. The command interpreter 120 may also be configured to analyze the voice input(s) to determine the one or more statements based on the voice input(s) as determined based on the user's speech.

In one configuration, the one or more statements spoken by the user 104 may be recognized as one or more words, commands, requests, questions and the like that may be spoken by the user 104 to communicate with the smart objects 102. The command interpreter 120 may additionally communicate with the neural network 108 to execute multimodal processing and/or machine learning to perform speech pattern recognition to determine one or more phrases spoken by the user 104 that may pertain to providing the one or more statements. The neural network 108 may provide speech data to the command interpreter 120 that may be further analyzed to determine the one or more statements. Upon determining the one or more statements, the command interpreter 120 may provide the one or more statements to the object data evaluation module 156 in the form of statement data.

The method 400 may proceed to block 408, wherein the method 400 may include receiving sensor data associated with physical actions of the user 104 with respect to the smart objects 102. In an exemplary embodiment, the object data evaluation module 156 may be configured to communicate with the camera system 126 to capture one or more images/video of the user 104 as one or more statements are spoken by the user 104. The object data evaluation module 156 may be configured to receive image data pertaining to facial expressions, body movements, eye movements, and/or body language of the user 104 as the user 104 speaks.

In an alternate embodiment, the object data evaluation module 156 may be configured to communicate with the camera(s) of the portable device 118 to capture one or more images/video of the point of view of the user 104 as one or more statements are spoken by the user 104. The object data evaluation module 156 may be configured to receive image data pertaining to body movements and/or body language of the user 104 as the user 104 speaks.

The method 400 may proceed to block 410, wherein the method 400 may include accessing the neural network 108 and providing communication data pertaining to the communication by the user 104 to the smart objects 102. In an exemplary embodiment, the object data evaluation module 156 may be configured to analyze the speech data received from the command interpreter 120. In particular, the module 156 may utilize the neural network 108 to analyze the statement data pertaining to the one or more statements interpreted by the command interpreter 120 to determine if the statements apply to one or more functions of one or more particular smart objects 102.

The object data evaluation module 156 may additionally analyze the image data provided by the camera system 126 pertaining to the image(s)/video of the user 104 to determine facial expressions, body movements, body language, and/or the eye gaze of the user 104 as the user 104 speaks to the smart objects 102. In some configurations, the object data evaluation module 156 may additionally analyze the image data provided by the camera(s) 140 of the portable device 118 pertaining to the image(s)/video of the point of view of the user 104 as the user 104 speaks to the smart objects 102.

The object data evaluation module 156 may thereby generate communication data that includes data that pertains to the one or more functions of the one or more respective smart objects 102 that the user's statements may apply to and facial expressions, body movements, body language, and/or the eye gaze of the user 104 as the user 104 speaks to the one or more respective smart objects 102. Upon generation of the communication data, the object data evaluation module 156 may communicate the communication data to the object personality setting module 158. The object personality setting module 158 may thereby provide the communication data to the neural network 108 to be further analyzed using machine learning.

The method 400 may proceed to block 412, wherein the method 400 may include determining if the user 104 is intending to interact with more than one smart object 102. In one embodiment, the object processing module 154 may communicate with the object personality setting module 158 and may determine that the user 104 is intending to interact with one or multiple smart objects based on the evaluation of the one or more statements provided by the user 104, as interpreted by the voice recognition system 116 and/or the command interpreter 120. In particular, the object personality setting module 158 may communicate with the voice recognition system 116 to determine if the voice recognition system 116 senses one or more object names, a trigger phrase(s), and/or a customizable command(s) that are assigned to one or more smart objects 102 and is spoken by the user 104. The object personality setting module 158 may thereby determine if the user 104 is communicating with one or multiple smart objects 102 based on the user stating one or more than one object name, a trigger phrase(s) that may apply to one or more than one smart object 102, and/or customizable commands that may be assigned to one or more than one smart object 102.

In an alternate embodiment, the object personality setting module 158 may determine that the user 104 is intending to interact with one or more than one smart object 102 based on sensor data associated with the physical actions of the user 104. In particular, the object personality setting module 158 may communicate with the camera system 126 of each of the one or more smart objects 102 and/or the camera(s) 140 of the portable device 118 to receive image data. The module 158 may thereby evaluate the image data to determine facial expressions, body language, body movements exhibited by the user 104 with respect to one or more smart objects 102 and/or a point of view of the user 104 to determine if the user 104 is looking toward one or more smart objects 102 as the user 104 is speaking and/or exhibiting physical actions.

If it is determined that the user 104 is intending to interact with more than one smart object 102 (at block 412), the method 400 may proceed to block 414, wherein the method 400 may include assigning a priority of communication for each respective smart object 102. In an exemplary embodiment, the object personality setting module 158 may communicate with the control unit 112 of the smart object 102 to access the storage unit 114 and retrieve the object identification data that may include, but may not be limited to, a make, a model, a serial number, a product number, a product code, a model date/date of production code, and one or more component codes that are each associated to each smart object 102. Upon retrieving the object identification data, the neural network 108 may be configured to query the neural network machine learning database 152 to access the records associated with the device identification of the smart objects 102.

In one embodiment, the neural network 108 may retrieve the one or more data fields and associated machine learning executable language that pertain to one or more time stamps and associated function codes to further analyze the frequency of utilization of the respective smart objects 102. The neural network 108 may communicate data associated with the one or more time stamps and associated function codes of each of the respective smart objects 102 to the object personality setting module 158. The object personality setting module 158 may thereby analyze the one or more time stamps and associated function codes to assign a priority to each of the one or more smart objects 102. The priority may ensure that a particular smart object 102 may virtually communicate with the user 104 without interrupting virtual communication between the user 104 and one or more additional smart objects 102.

In an additional embodiment, the object personality setting module 158 may additionally utilize the neural network 108 to analyze the user's statements with respect to the one or more smart objects 102 based on statement data provided by the command interpreter 120 of the respective smart objects 102. Additionally, the object personality setting module 158 may analyze physical actions of the user 104 based on image data provided by the camera system 126 of the respective smart objects 102 and/or the camera(s) 140 of the portable device 118. Based on the analysis of the user's statements and/or the physical actions, the object personality setting module 158 may assign a priority to each of the multiple smart objects 102 to ensure that a particular smart object 102 may virtually communicate with the user 104 without interrupting virtual communication between the user 104 and one or more additional smart objects 102.

If it is determined that the user 104 is not intending to interact with more than one smart object 102 (at block 412) or that a priority of communication is assigned for each respective smart object 102 (at block 414), the method 400 may proceed to block 416, wherein the method 400 may include selecting behavioral attributes and communication patterns of the smart objects 102 based on the communication data, one of more functions of the smart objects 102, and/or a frequency of use of the smart objects 102. In one embodiment, the object personality setting module 158 may communicate with the neural network 108 to execute machine learning to set a personality and communication patterns of the smart object 102.

In particular, upon receiving the communication data, the neural network 108 may utilize the processor 148 to execute machine learning to provide artificial intelligence capabilities to analyze the user's statements and physical actions, one or more functions of the smart object 102, and the frequency of utilization of the smart object 102. In one embodiment, the object personality setting module 158 may communicate with the control unit 112 of the smart object 102 to access the storage unit 114 and retrieve the object identification data associated to the respective smart objects 102. Upon retrieving the object identification data, the neural network 108 may be configured to access and query the neural network machine learning database 152 to access the record(s) associated with the device identification of the smart objects 102.

Upon accessing the record(s) associated with the smart objects 102 on the neural network machine learning database 152, the neural network 108 may retrieve the one or more data fields and associated machine learning executable language that may pertain to one or more functions (function codes) that may be executed by the respective smart objects 102. Additionally, the neural network 108 may retrieve customization information inputted by the user 104 that may pertain to nickname(s), key word(s), feature descriptions associated with the smart objects 102, one or more customizable functions that the user 104 may utilize the smart objects 102 to execute, and/or a priority that may be assigned to each respective smart object 102 (assigned at block 414).

In one embodiment, the neural network 108 may retrieve the one or more data fields and associated machine learning executable language that pertain to one or more time stamps and associated function codes to further analyze the frequency of utilization of the one or more functions of the respective smart objects 102. Upon analyzing the one or more functions of the smart object 102, the frequency of utilization of one or more functions of the smart object 102, and/or customization information pertaining to subjective information pertaining to the user's utilization of the respective smart objects 102, the neural network 108 may further analyze the communication data pertaining to the user's communication (e.g., verbal and behavioral) with respect to the smart object 102.

In particular, the neural network 108 may execute machine learning and/or deep learning algorithms and may determine a context of the user's statements and the user's actions. The context of the user's statements and the user's actions may be determined based on the analysis of the one or more functions and/or the frequency of use of one or more functions of the smart objects 102. Accordingly, the neural network 108 may determine one or more words, commands, requests, questions and the like that may be spoken by the user 104 that relate to one of more functions that may be executed the respective smart objects 102 and/or one or more functions that may be frequently utilized by the user 104. For example, if a smart object 102 is configured as a smart lamp (not shown), the neural network 108 may analyze communication data with respect to the user's statement “turn ON” and/or the user's hand gesture of waving to determine the context of the user's statement pertaining to turning on the smart lamp.

Upon analyzing the communication data, one or more functions of the smart object 102, and/or the frequency of use of the one or more functions of the smart object 102, the neural network 108 may communicate respective data to the object personality setting module 158 pertaining to the determination of one or more words, commands, requests, questions and the like that may be spoken by the user 104 and/or facial expressions, body language, eye gaze, body movements exhibited by the user 104 during virtual communication with each respective smart object 102 that relate to one of more functions that may be executed by the smart objects 102 and/or one or more functions that may be frequently utilized by the user 104.

In one configuration, the object personality setting module 158 may access the smart object profile on the storage unit 114 of the smart objects 102 and may retrieve behavioral attribute and communication pattern data (e.g., stored vocal statements and virtual representation behavioral attributes that may be programmed by a manufacturer and/or a third-party). The module 158 may accordingly select one or more behavioral attributes that may be associated with the virtual representation and one or more communication patterns that may be applicable to the one or more words, commands, requests, questions and the like that may be spoken by the user 104, one or more functions that may be executed by the smart object 102, and/or one or more functions that may be frequently utilized by the user 104.

In some embodiments, the object personality setting module 158 may also utilize the customization information and/or data included within the user profile to select one or more behavioral attributes associated with the virtual representation and one or more communication patterns that are specifically applicable to the user 104 for the respective smart objects 102. In other words, the virtual representation and one or more communication patterns may be based on one or more of the statement(s) spoken by the user 104 to the respective smart objects 102, one or more functions that may be executed by the respective smart objects 102, the frequency of the user's use of the respective smart objects 102, and/or the customization information and/or data included within the user profile stored on the storage unit 114 of the respective smart objects 102.

As an illustrative example, the virtual representation (that includes the one or more behavioral attributes) and communication patterns that may be set may be based on the presence of the user 104 within the predetermined proximity of a smart object 102 configured as a smart refrigerator which may be exhibited by the virtual representation of the smart refrigerator greeting the user 104 with a smile and the communication patterns that pertain the smart refrigerator vocally communicating the user's name. The virtual representation and communication patterns may also be based on the frequency of use of the smart refrigerator by the user 104 which may be exhibited by the smart refrigerator welcoming the user 104 back the refrigerator. Additionally or alternatively the virtual representation and communication patterns may be based on one or more functions that may be executed by the smart refrigerator which may be exhibited by the smart refrigerator asking the user 104 if they would like some ice. Additionally or alternatively, the one or more behavioral attributes associated with the virtual representation and communication patterns may be based and/or statements spoken by the user 104 to the smart refrigerator which may be exhibited by the smart refrigerator answering the user's command to decrease the freezer temperature with an affirmative statement upon completing a function of decreasing the freezer temperature.

The method 400 may proceed to block 418, wherein the method 400 may include presenting a virtual personality of the smart objects 102 to virtually communicate with the user 104 based on the virtual communication patterns and behavioral attributes. Upon selecting the behavioral attributes and communication patterns of the smart object 102, the object personality setting module 158 may communicate respective data to the output control module 160. In an exemplary embodiment, upon receiving data associated with the behavioral attributes and communication patterns of the smart object 102, the output control module 160 may communicate data pertaining to the virtual communication patterns and behavioral attributes associated with the virtual representation to the control unit 112 of the smart objects 102.

In some embodiments, when it is determined that the user 104 is interacting with multiple smart objects 102 and a priority is assigned to each of the multiple smart objects 102, the output control module 160 may additionally communicate data pertaining to the priority assigned to each of the respective smart objects 102 to the control unit 112 of each smart object 102 to enable each smart object 102 to communicate with the user 104 based on the assigned priority.

The control unit 112 may analyze the data and may operably control the display unit 122 to present a virtual representation of the smart object 102 in a manner that is representative of the associated behavioral attributes. For example, the virtual representation may be presented with facial expressions and body language that represent the behavioral attributes selected by the object personality setting module 158. The control unit 112 may additionally operably control the speaker system 124 to utilize one or more of the speakers of the smart object 102 to output a synthesized voice to communicate vocal communication patterns with the user 104 during virtual communication between the user 104 and the smart objects 102.

The control unit 112 may also control the speaker system 124 to output the synthesized voice in a particular manner (e.g., volume, inflection, tone) that is associated with the behavioral attributes. In some configurations, one or more speakers of the speaker system 124 may be utilized to provide sound directivity in a direction of the user 104 based on the location of the user 104 with respect to the smart objects 102, as determined based on sensor data that may be evaluated by the object processing module 154.

In an additional embodiment, the output control module 160 may additionally or alternatively communicate data pertaining to the virtual communication patterns and behavioral attributes to the processor 134 of the portable device 118. The processor 134 may analyze the data and may operably control the display unit 136 to present a virtual representation of the smart object 102 in a manner that is representative of the behavioral attributes and is presented as an augmented reality image that is overlaid upon the smart objects 102 (e.g., similar to the illustrative example of FIG. 2B).

The processor 134 may additionally operably control the speaker system 124 to output a synthesized voice to communicate vocal communication patterns with the user 104 during virtual communication between the user 104 and the smart objects 102. The processor 134 may also control the speaker system 124 to output the synthesized voice in a particular manner (e.g., volume, inflection, tone) that is associated with the behavioral attributes.

In one or more embodiments, the output control module 160 may communicate data to the control unit 112 and/or the processor 134 to provide the synthesized voice of each of the smart object 102 in a respective manner that may be based on one or more factors that may include, an age of the smart object 102, one or more functions of the smart object 102, a frequency of use of the smart object 102 by the user 104, a frequency of use of particular functions of the smart object 102 by the user 104, the statement(s) communicated by the user 104 to the respective smart objects 102 (that may pertain to one or more functions), physical actions of the user 104 during virtual communication with respective smart objects 102, and a priority of communication as determined for each smart object 102 when the user 104 is determined to interact with multiple smart objects 102.

In one embodiment, the output control module 160 may also communicate data to the control unit 112 to operably control the smart objects 102 to execute one or more functions of the respective smart objects 102. In particular, the one or more functions may be executed based on one or more communication patterns that are virtually communicated to the user 104. In additional embodiments, the output control module 160 may also communicate data to the control unit 112 to utilize the communication unit 130 to communicate data pertaining to the virtual communication with the user 104 and/or one or more functions that are executed by the respective smart objects 102 to be communicated to one or more additional smart objects 102. For example, a smart object 102 configured as a smart washer may communicate data referring to a function of completing a washing cycle to another smart object 102 configured as a smart dryer which may enable the application 106 to present a virtual personality of the smart dryer to the user 104.

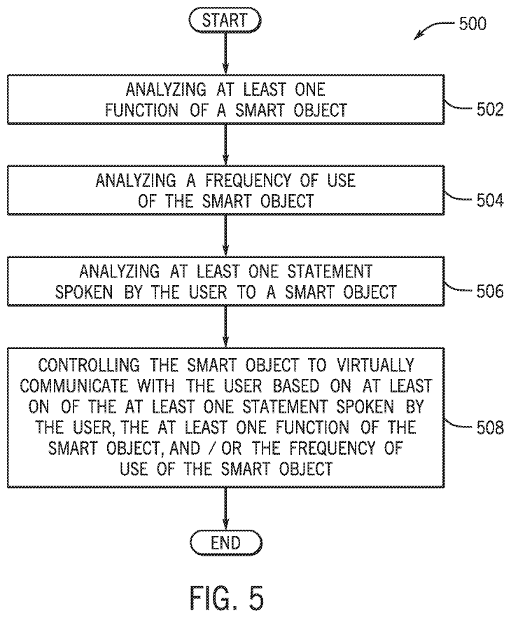

FIG. 5 is a process flow diagram of a method 500 for providing smart object virtual communication according to an exemplary embodiment. FIG. 5 will be described with reference to the components of FIG. 1 though it is to be appreciated that the method of FIG. 5 may be used with other systems and/or components. The method 500 may begin at block 502, wherein the method 500 may include analyzing at least one function of a smart object 102.

The method 500 may proceed to block 504, wherein the method 500 may include analyzing a frequency of use of the smart object 102. The method 500 may proceed to block 506, wherein the method 500 may include analyzing at least one statement spoken by the user to the smart object 102. The method 500 may proceed to block 508, wherein the method 500 may include controlling the smart object 102 to virtually communicate with the user 104 based on at least one of: the at least one statement spoken by the user 104, the at least one function of the smart object 102, and the frequency of use of the smart object 102.

The embodiments discussed herein can also be described and implemented in the context of non-transitory computer-readable storage medium storing computer-executable instructions. Non-transitory computer-readable storage media includes computer storage media and communication media. For example, flash memory drives, digital versatile discs (DVDs), compact discs (CDs), floppy disks, and tape cassettes. Non-transitory computer-readable storage media can include volatile and nonvolatile, removable and non-removable media implemented in any method or technology for storage of information such as computer readable instructions, data structures, modules or other data. Non-transitory computer readable storage media excludes transitory and propagated data signals.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for providing smart object virtual communication, comprising:
analyzing at least one function of a smart object;
analyzing a frequency of use of the smart object;
analyzing at least one statement spoken by a user to the smart object; and
controlling the smart object to virtually communicate with the user based on at least one of: the at least one statement spoken by the user, the at least one function of the smart object, and the frequency of use of the smart object.

2. The computer-implemented method of claim 1, further including training a neural network on at least one instance of virtual communication between the user and the smart object, the at least one function of the smart object, the frequency of use of the smart object, and user customization information with respect to the smart object.

3. The computer-implemented method of claim 2, wherein the user customization information includes at least one of: an object name selected by the user that pertains to the smart object, a trigger phrase, and a command phrase that is pre-programmed to command the smart object to enable a particular function.

4. The computer-implemented method of claim 2, further including determining that the user is within a predetermined proximity of the smart object, wherein vocal data associated with the at least one statement spoken by the user is analyzed in comparison with stored voice identification data associated with the user to determine that the user is within the predetermined proximity of the smart object.

5. The computer-implemented method of claim 2, wherein analyzing the at least one function includes accessing the neural network and determining at least one function code that is associated with the smart object, wherein the at least one function code is analyzed to determine the at least one function of the smart object.

6. The computer-implemented method of claim 5, wherein analyzing the frequency of use includes accessing the neural network and analyzing at least one time stamp that is associated with utilization of at least one function of the smart object by the user.

7. The computer-implemented method of claim 1, wherein analyzing the at least one statement spoken by the user includes sensing a voice and determining human speech patterns to be analyzed to determine one or more statements that are communicated to the smart object by the user.

8. The computer-implemented method of claim 1, wherein analyzing the at least one statement spoken includes determining at least one of: words, commands, requests, and questions that are spoken by the user that relate to at least one of: the at least one function that is executed the smart object, and at least one function that is frequently utilized by the user.

9. The computer-implemented method of claim 1, wherein controlling the smart object to virtually communicate with the user includes providing a synthesized voice of the smart object that is based on at least one factor that includes at least one of: an age of the smart object, the at least one function of the smart object, the frequency of use of the smart object, at least one statement spoken by the user, at least one physical action exhibited by the user, and a priority of communication assigned to the smart object.

10. A system for providing smart object virtual communication, comprising:
a memory storing instructions when executed by a processor cause the processor to:
analyze at least one function of a smart object;
analyze a frequency of use of the smart object;
analyze at least one statement spoken by a user to the smart object; and
control the smart object to virtually communicate with the user based on at least one of: the at least one statement spoken by the user, the at least one function of the smart object, and the frequency of use of the smart object.

11. The system of claim 10, further including training a neural network on at least one instance of virtual communication between the user and the smart object, the at least one function of the smart object, the frequency of use of the smart object, and user customization information with respect to the smart object.

12. The system of claim 11, wherein the user customization information includes at least one of: an object name selected by the user that pertains to the smart object, a trigger phrase, and a command phrase that is pre-programmed to command the smart object to enable a particular function.

13. The system of claim 11, further including determining that the user is within a predetermined proximity of the smart object, wherein vocal data associated with the at least one statement spoken by the user is analyzed in comparison with stored voice identification data associated with the user to determine that the user is within the predetermined proximity of the smart object.

14. The system of claim 11, wherein analyzing the at least one function includes accessing the neural network and determining at least one function code that is associated with the smart object, wherein the at least one function code is analyzed to determine the at least one function of the smart object.

15. The system of claim 14, wherein analyzing the frequency of use includes accessing the neural network and analyzing at least one time stamp that is associated with utilization of at least one function of the smart object by the user.

16. The system of claim 10, wherein analyzing the at least one statement spoken by the user includes sensing a voice and determining human speech patterns to be analyzed to determine one or more statements that are communicated to the smart object by the user.

17. The system of claim 10, wherein analyzing the at least one statement spoken includes determining at least one of: words, commands, requests, and questions that are spoken by the user that relate to at least one of: the at least one function that is executed the smart object, and at least one function that is frequently utilized by the user.

18. The system of claim 10, wherein controlling the smart object to virtually communicate with the user includes providing a synthesized voice of the smart object that is based on at least one factor that includes at least one of: an age of the smart object, the at least one function of the smart object, the frequency of use of the smart object, at least one statement spoken by the user, at least one physical action exhibited by the user, and a priority of communication assigned to the smart object.

19. A non-transitory computer readable storage medium storing instructions that when executed by a computer, which includes a processor perform a method, the method comprising:
analyzing at least one function of a smart object;
analyzing a frequency of use of the smart object;
analyzing at least one statement spoken by a user to the smart object; and
controlling the smart object to virtually communicate with the user based on at least one of: the at least one statement spoken by the user, the at least one function of the smart object, and the frequency of use of the smart object.

20. The non-transitory computer readable storage medium of claim 19, wherein controlling the smart object to virtually communicate with the user includes providing a synthesized voice of the smart object that is based on at least one factor that includes at least one of: an age of the smart object, the at least one function of the smart object, the frequency of use of the smart object, at least one statement spoken by the user, at least one physical action exhibited by the user, and a priority of communication assigned to the smart object.
